(19) United States
(12) Patent Application Publication
(10) Pub. No.: US 2025/0004118 A1
(43) Pub. Date: Jan. 2, 2025

(54) RADAR SYSTEM AND METHOD USING A VIRTUAL SENSOR

(71) Applicant: Robert Bosch GmbH, Stuttgart (DE)

(72) Inventors: Armin Himmelstoss, Weissach Im Tal (DE); Daniel Schindler, Korntal-Münchingen (DE)

(21) Appl. No.: 18/681,953

(22) PCT Filed: Aug. 31, 2022
(86) PCT No.: PCT/EP2022/074237

§ 371 Date: Feb. 7, 2024

(30) Foreign Application Priority Data
Sep. 14, 2021 (DE) 10 2021 210 121.6

(51) Int. Cl. G01S 13/00; G01S 7/40; G01S 13/42; G01S 13/931

(52) U.S. Cl. CPC G01S 13/003; G01S 7/4026; G01S 13/42; G01S 13/931

(57) ABSTRACT

A radar system. The radar system includes at least three radar sensors which are connected to one another in a phase-coherent manner. A first radar sensor and a second radar sensor are disposed spaced apart from one another. A virtual sensor is created by means of bistatic measurement of at least the first radar sensor and the second radar sensor using the MIMO method. At least one third radar sensor is disposed offset to the virtual sensor. The radar system is configured to acquire an elevation angle of a target using the virtual sensor and the at least one third sensor.

### FIELD

The present invention relates to a radar system that acquires an elevation angle of a target using a virtual sensor. The present invention also relates to a radar system that enables calibration and/or misalignment detection of radar sensors of the radar system using a virtual sensor. The present invention further relates to a method for acquiring the elevation angle of the target and/or for calibration and/or for misalignment detection using the virtual sensor.

### BACKGROUND INFORMATION

Nowadays, radar sensors are used to acquire the distance, speed and angle of a target relative to the sensor. The angles of interest are the azimuth angle, which describes the angle to the target in the horizontal plane, and the elevation angle, which describes the angle to the target in the vertical plane, i.e., along the height. To do this, individual radar sensors send out a signal that is reflected by the target. In the case of monostatic measurements, the reflected signal is received and evaluated by the same radar sensor. In the case of bistatic measurements, the reflected signal is received by a second radar sensor which is disposed spatially separated from the first radar sensor. The distance, speed or angle of the target are then ascertained on the basis of the known distance between the sensors.

A plurality of transmitting antennas and receiving antennas of the sensors can be involved in the transmission as well. Such a transmission system is known as MIMO (multiple-input multiple-output).

Radar systems in which three radar sensors are used to acquire both the azimuth angle and the elevation angle are conventional. In these radar systems, however, the sensor data are either processed individually in each sensor by means of a standalone target evaluation and then the ascertained identical targets of the plurality of sensors are merged in a central control unit or an external computing device (also cloud computing). Or, the sensor data are merged at object level or location level in a central control unit. However, no additional target angle information is obtained from the combination of the sensors; instead each sensor contributes its individually measured target angle information/target angle data. A weighting of the reliability information of the individual sensors is therefore often taken into account.

### SUMMARY

According to the present invention, a radar system comprising at least three radar sensors is provided. According to an example embodiment of the present invention, the radar sensors are configured and disposed in such a way that their fields of view overlap. The radar sensors are connected to one another in a phase-coherent manner, so that the phase differences of antennas of the sensors can be evaluated together. The sensors are synchronized with one another by means of clock synchronization and/or high-frequency synchronization, for example via a common local oscillator, a quartz clock, a bus clock or the like. The at least three radar sensors thus form a phase-coherent cooperative sensor network.

A first radar sensor and a second radar sensor are disposed spaced apart from one another. The radar sensors can be disposed in separate modules. The radar sensors can alternatively also be disposed spaced apart from one another in a common housing. The first radar sensor and the second radar sensor are disposed at the same height on a common horizontal plane, for instance. The first radar sensor and the second radar sensor can generally be disposed in any plane and at any angle to the horizontal. Only the installation angles and positions of the at least three radar sensors need to be known.

According to an example embodiment of the present invention, the first radar sensor and the second radar sensor create a virtual sensor by means of bistatic measurement using the MIMO method (multiple-input multiple-output). In this application, a “virtual sensor” is understood to be an imaginary sensor that is synthesized from the combination of two real sensors. MIMO is used between the sensors to create a virtual sensor between the two real sensors. Both sensors transmit and receive the signal of the respective other sensor. This opens a virtual aperture across the two sensors, in the middle of which the virtual sensor is then located. Other radar sensors can be involved in the creation of the virtual sensor. In some case, the overall virtual aperture may be incomplete (sparse). It can therefore be provided that only measurement path combinations of transmitting antennas and receiver antenna that belong to the virtual sensor are used. These measurement path combinations always represent bistatic measurements, i.e., one of the two sensors transmits and the other sensor receives and vice versa. Since the individual radar sensors can comprise multiple transmitting antennas and receiving antennas, there can also be multiple bistatic combinations that belong to the virtual sensor. The bistatic measurement paths belonging to the virtual sensor can then be evaluated in a conventional manner (as in the case of a conventional radar sensor), e.g., to acquire an azimuth angle of a target.

A first solution according to an example embodiment of the present invention provides that at least one third radar sensor is disposed offset to the virtual sensor in order to acquire an elevation angle. The arrangement of the radar sensors is such that the third radar sensor and the virtual sensor have different antenna positions in vertical direction, i.e., with respect to elevation. The antennas can be offset by positioning the sensors differently, but also by simply offsetting the antennas within the sensors. The at least one third radar sensor can in particular be disposed such that it is offset in height relative to the virtual sensor. Alternatively, the at least one third radar sensor can be disposed such that it is rotated relative to the plane between the first radar sensor and the second radar sensor. The antennas of the sensors are offset in height relative to one another as a result of the rotation; in particular if they are same radar sensors. The at least one third radar sensor can particularly preferably be disposed at the same height rotated 180°. An elevation angle of a target is acquired using the virtual sensor and the at least one third sensor. The data of the virtual sensor and the data of the at least one third radar sensor are evaluated together in a phase-coherent manner to acquire the elevation angle of the target.

On the one hand, the joint evaluation can be based on raw data, such as time signals, spectra, etc., of the at least three radar sensors. The raw data is evaluated in a conventional manner, analogous to an evaluation of individual sensors, with the difference that all data of the radar system are evaluated together in a phase-coherent manner as if it were a single sensor.

Alternatively or additionally, according to an example embodiment of the present invention, the joint evaluation can be based on at least partially preprocessed data. The multistage evaluation of the preprocessed data is possible if the complex amplitude values of the radar sensors and the virtual sensor can be used. This allows the data to be offset against one another on different planes, e.g., by 2D FFT (two-dimensional Fast Fourier transformation), CFAR (constant false alarm rate) or by angle evaluation. The respective calculation steps are carried out in a conventional manner, analogous to those in an evaluation of individual sensors. Calculation steps that have already been carried out (such as 2D FFT) can be omitted. One exception is the coherent calculation based on already calculated target angles from the radar sensors. In this case, each of the radar sensors, and therefore also the virtual sensor, provides both the angle and the complex-valued amplitude after the angle evaluation. The amplitudes of the sensors to be combined, i.e., the virtual sensor and the at least one third sensor, are offset against one another in a phase-coherent manner via the complex-valued amplitudes based on the relative positions, i.e., the offset of their antennas. This type of evaluation represents a new angle calculation. The angle calculations can therefore be carried out with less effort, because the approximate azimuth angle and/or the approximate elevation angle can already be roughly calculated by the radar sensors and the phase-coherent joint evaluation only has to be carried out in a narrow angular range around the already roughly calculated angle.

As a result, the radar sensors and the virtual sensor work together in a phase-coherent manner to acquire both the elevation angle and the azimuth angle. This makes it possible to acquire both the azimuth angle and the elevation angle in a second plane, even with radar sensors that only have a one-dimensional antenna arrangement and are therefore only able to acquire a target angle in one plane (typically the azimuth angle).

If the radar sensors already have a two-dimensional antenna arrangement, with which the target angles can be acquired in two planes (i.e., the azimuth angle and the elevation angle), the radar sensors working together in a phase-coherent manner and the virtual sensor can improve the angular resolution in the second plane, i.e., typically for the elevation angle.

A second solution according to an example embodiment of the present invention provides that the third radar sensor is disposed at the location of the virtual sensor; thus centrally between the first radar sensor and the second radar sensor. The arrangement of the radar sensors is such that the third radar sensor and the virtual sensor have overlapping antenna positions in vertical direction, i.e., with respect to elevation. The overlap of the antenna channels of the virtual sensor and the at least one third radar sensor achieves a phase synchronization. For this purpose, the received phase information of at least one of the overlapping antenna channels of the virtual sensor and the phase information of at least one of the overlapping antenna channels of the at least one third radar sensor are compared. The phase information of the virtual sensor and the phase information of the at least one third radar sensor are evaluated together in a phase-coherent manner. The phase synchronization makes it possible to calibrate each of the radar sensors. Ideally, the phase values of the overlapping channels will then match during operation. If not, the phases can be readjusted by calculating the difference. If more than one antenna channel overlaps, misalignment can still be detected and/or corrected depending on the number and positions of the overlapping elements. A distinction for the type of misalignment can be made between phase offset and phase gradient. A phase offset is constant for all overlapping antenna channels and indicates an error in the assembly or arrangement of the sensors with respect to the spatial directions. A phase gradient changes between multiple overlapping antenna channels and indicates an error caused by tilting or rotation of the sensors in the direction of the azimuth or the elevation. As already described above, the joint evaluation can be based on raw data of the sensors and can alternatively or additionally use preprocessed data.

The virtual sensor has the advantage that the effort in terms of memory and computation is reduced, because unneeded measurement path combinations can be processed separately or discarded.

The radar sensors can all be configured the same. Alternatively, the radar sensors can be configured differently from one another. The third radar sensor can in particular differ from the first radar sensor and from the second radar sensor. However, the first radar sensor and the second radar sensor can also differ.

According to an example embodiment of the present invention, if one or more of the radar sensors is configured to acquire the elevation angle (e.g., because the radar sensor has a two-dimensional antenna arrangement), the elevation angle can be acquired as a function of the distance to the target. The improvement of the elevation resolution by the combined evaluation is particularly advantageous at greater distances to the target in order to detect small obstacles early. At close range, an evaluation with poorer resolution is sufficient. The radar system therefore does not have to evaluate all of the data of all of the sensors at the same time, but can carry out a joint or separate evaluation, e.g., depending on the distance to the target.

According to an example embodiment of the present invention, the calculation of the elevation angle (and the azimuth angle) by means of the virtual sensor in the radar system is preferably carried out in an electronic control unit of the radar sensors of the radar system. For so-called satellite sensors, which work in conjunction with a central control unit, the calculation of the elevation angle (and the azimuth angle) can also be carried out in the central control unit. Alternatively, it is possible to carry out the calculation on an external computing device. Cloud computing can also be provided here.

According to an example embodiment of the present invention, the computer program is configured to carry out each step of the method of the present invention, in particular when it is carried out on a computational device or control unit. It enables the implementation of the method in a conventional electronic control unit without having to make any structural changes. For this purpose, it is stored on the machine-readable storage medium. Installing the computer program on a conventional electronic control unit provides the electronic control unit that is configured to acquire the elevation angle of a target and/or calibrate and/or detect a misalignment of radar sensors. As described above, this can be an electronic control unit of a radar sensor or a central electronic control unit or an external computing device, in particular in the context of cloud computing.

The radar system according to the present invention is preferably used in a motor vehicle. The radar sensors are preferably disposed at the front and optionally at the rear of the vehicle. However, the radar system, and in particular the creation of the virtual sensor, is not tied to a vehicle axis or a specific orientation. The radar system can be applied to all relevant field of view planes in the vehicle.

### BRIEF DESCRIPTION OF THE DRAWINGS

Embodiment examples of the present invention are shown in the figures and explained in more detail in the following description.

FIGS. 1A to 1F show schematic illustrations of different arrangements of the radar system according to the present invention.

FIG. 2 shows a schematic illustration of first embodiment example of the radar system according to the present invention.

FIG. 3 shows a schematic illustration of second embodiment example of the radar system according to the present invention.

FIG. 4 shows a schematic illustration of third embodiment example of the radar system according to the present invention.

FIG. 5 shows a flowchart of an embodiment example of the method according to the present invention.

### DETAILED DESCRIPTION OF EXAMPLE EMBODIMENTS

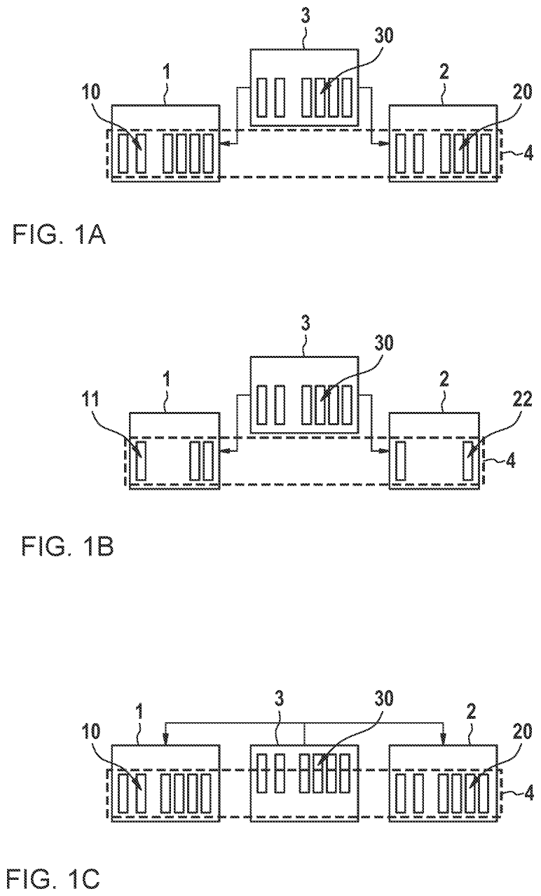

FIGS. 1A-1F show different arrangements of a first radar sensor 1, a second radar sensor 2 and a third radar sensor 3 during assembly of the radar system according to the present invention. The radar sensors 1, 2, 3 each comprise an antenna array 10-13, 20-23, 30-33 with which radar signals can be transmitted and received. The radar sensors 1, 2, 3 can be configured the same or can differ. Reference in this respect is made to the individual embodiment examples. All of the radar sensors 1, 2, 3 are connected to one another using the MIMO method (multiple-input multiple-output) and can receive and evaluate the radar signal of the respective other radar sensors 1, 2, 3. The radar sensors 1, 2, 3 are coupled to one another in a phase-coherent manner, so that the phase differences of the antenna arrays 10-13, 20-23, 30-33 of each radar sensor 1, 2, 3 can be evaluated together. These couplings are shown in FIGS. 1A-1F as arrows. The first radar sensor 1 and the second radar sensor 2 carry out a bistatic measurement using the MIMO method. The first radar sensor 1 and the second radar sensor 2 are furthermore synchronized with one another by means of clock synchronization and high-frequency synchronization. This creates a virtual aperture 4, which encloses the surface of the included radar sensors 1, 2.

In the embodiment examples of FIGS. 1A-1E, the third radar sensor 3 acts as a master that transmits a radar signal with a clock. The clock is produced by a local oscillator, a quartz clock or a bus clock, for example. The radar signal of the third radar sensor 3 is received by the two radar sensors 1, 2. The radar sensors 1, 2 act as slaves and output a radar signal which is phase-coherent to the radar signal of the third radar sensor 3.

In the example arrangement of the embodiment example according to FIG. 1A, the third radar sensor 3 is disposed in a higher position than the two other radar sensors 1, 2. The antenna array 30 of the third sensor 3 is thus disposed in the direction of the vertical above the antenna array 10 of the first radar sensor 1 and the antenna array 20 of the second radar sensor 2 as well as the virtual aperture 4. However, it can also be provided that the third radar sensor 3 is disposed below. In FIG. 1A, all of the radar sensors 1, 2, 3 and all of their antenna arrays 10, 20, 30 are configured identically. The embodiment example according to FIG. 1B differs from the embodiment example according to FIG. 1B in that the radar sensors 1, 2, 3 differ: The first radar sensor 1 comprises a first antenna array 11, the second radar sensor 2 comprises a second antenna array 22 and the third radar sensor 3 comprises a third antenna array 30, all of which differ from one another. The first radar sensor 1 and/or the second radar sensor 2 are repeaters, for example. In other embodiment examples, two of the radar sensors 1, 2, 3 can also be configured the same and only one can differ.

In another example arrangement of the embodiment example according to FIG. 1C, all of the radar sensors 1, 2, 3 are at the same height and are configured identically. The third radar sensor 3, which is located in the middle of the two other radar sensors 1, 2, is rotated 180°. The antenna array 30 of the third sensor is thus likewise disposed at a different height than the antenna arrays 10, 20 of the two other radar sensors 1, 2.

FIG. 1D shows an arrangement in which the first radar sensor 1 and the third radar sensor 3 are disposed at the same height and are configured identically. The second radar sensor 2 is disposed above the two other radar sensors 1, 3 and also differs structurally from the two other radar sensors 1, 3, primarily in that it has a different antenna array 22. The third radar sensor 3 is thus disposed in an edge position. The virtual aperture 4 is furthermore created by the first radar sensor 1 and the second radar sensor 2.

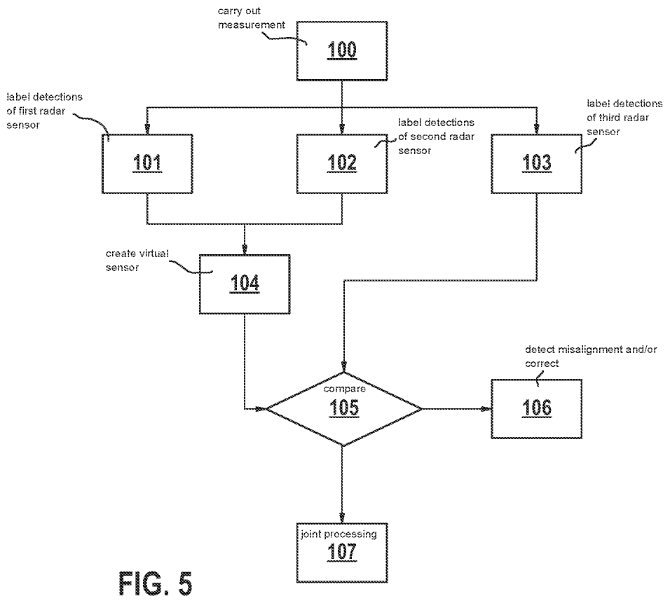

In the embodiment example of FIG. 1E, all of the radar sensors 1, 2, 3 are disposed at different heights and are configured differently from one another with different antenna arrays 11, 22, 30. The third radar sensor 3 is located in the middle of the two other radar sensors 1, 2. The virtual aperture 4 is furthermore created by the first radar sensor 1 and the second radar sensor 2. This arrangement provides a particularly good resolution of the elevation when ascertaining the elevation angle if all of the signals of the sensors are evaluated together. Reference is made here to FIG. 5 and the associated description. The third sensor comprises antenna positions that overlap with a virtual sensor (not shown here). The arrangement can therefore be used for phase calibration and misalignment detection. The virtual sensor creates a redundancy with respect to the third radar sensor 3.

In the embodiment example of FIG. 1F, a central control unit 5 is provided, which is connected to each of the radar sensors 1, 2, 3. The radar sensors 1, 2, 3 are referred to as satellite sensors and act as quasi-slaves. The central control unit uses a local oscillator (or alternatively a quartz clock or a bus clock) to generate a common phase/frequency reference signal as a clock for coherent processing. The radar sensors 1, 2, 3 synchronize themselves phase-coherently via the common phase/frequency reference signal. The arrangement of the radar sensors 1, 2, 3 here is analogous to the embodiment example according to FIG. 1C, but is not limited to it.

In other embodiment examples, the arrangements of the radar sensors 1, 2, 3 can also be mirrored in accordance with FIGS. 1A-1F.

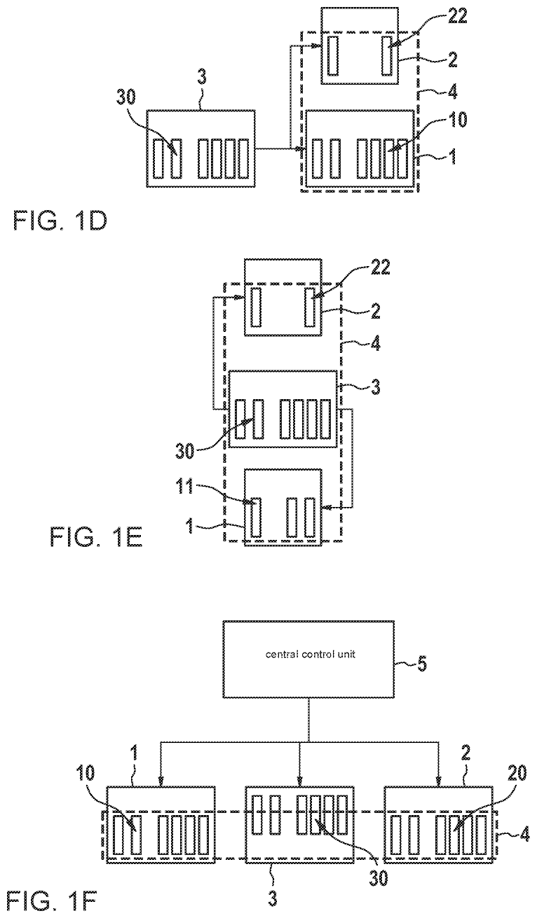

The acquisition of the elevation angle of a target is described in the following with reference to FIGS. 2 to 4. FIGS. 2 to 4 show the radar sensors 1, 2, 3 and the virtual aperture 4, which is created by the first radar sensor 1 and the second radar sensor, as already described with reference to FIGS. 1A-1F. The radar sensors 1, 2, 3 are disposed here according to the embodiment example of FIG. 1A, i.e., the third radar sensor 3 is disposed centrally to the two other radar sensors 1, 2 and above them in terms of height. The acquisition of the elevation angle is not limited to this arrangement, however, and any other arrangement of the radar sensors 1, 2, 3, in particular any arrangement shown in FIGS. 1B-1F, i.e., also the arrangement of the third radar sensor 3 in an edge position, can be used. The respectively evaluated signals are dependent on the arrangement of the radar sensors 1, 2, 3. The clock can be specified by one of the radar sensors 1, 2, 3, in particular by the third radar sensor 3 acting as the master, or by a central control unit 5 as described in the embodiment example of FIG. 1F.

FIGS. 2 to 4 further show a virtual sensor 6, which is created by bistatic measurement of the real first radar sensor 1 and the real second radar sensor 2 using the MIMO method. The virtual sensor 6 is created in the middle of the virtual aperture 4 of the two radar sensors 1, 2. The virtual sensor 6 correspondingly comprises a virtual antenna array 60 or 63.

To acquire the elevation angle, the data of the virtual sensor 6 created from the bistatic measurement is combined with the data of the real third radar sensor 3 which is carrying out a monostatic measurement. The third radar sensor 3 is offset in height relative to the virtual sensor 6; in this example the third radar sensor 3 is located above the virtual sensor 6, and in other not-depicted examples it is located below. The virtual sensor 6 and the third radar sensor 3 in turn create a virtual aperture 7.

In the first embodiment example according to FIG. 2, the radar sensors 1, 2, 3 each comprise one-dimensional antenna arrays 10, 20, 30. The virtual aperture 7 extends in elevation direction and includes the sensor surface of the one-dimensional antenna array 30 of the third radar sensor 3 and the virtual antenna array 60 of the virtual sensor 6. The acquisition of the elevation angle is achieved by the combined evaluation of the bistatic measurement via the virtual sensor 6 and the monostatic measurement via the real third radar sensor 3.

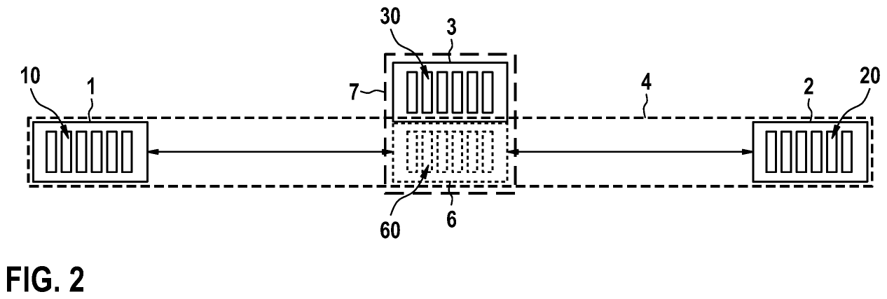

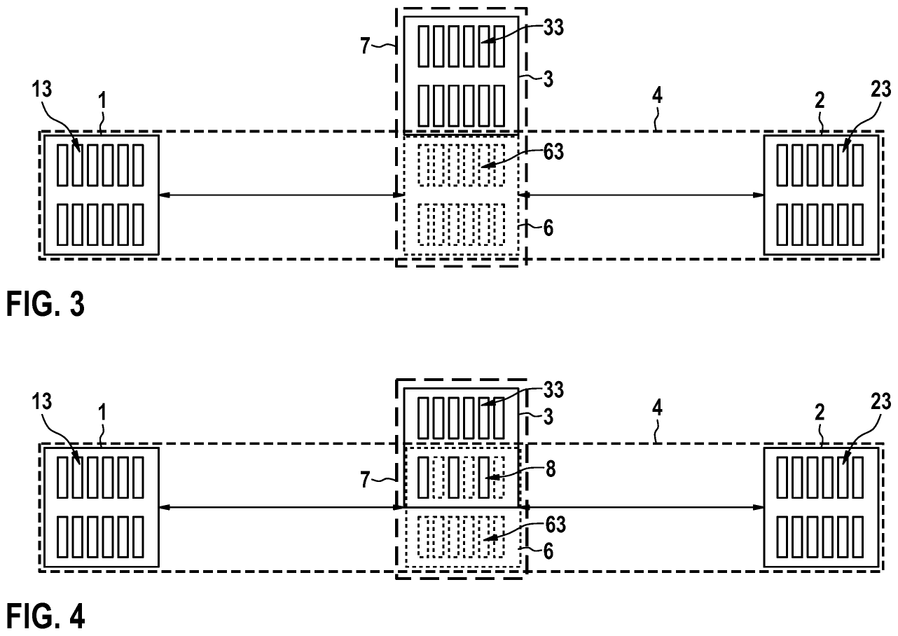

In the second and third embodiment examples of FIGS. 3 and 4, the radar sensors 1, 2, 3 each comprise a two-dimensional antenna array 13, 23, 33. The combined evaluation of the bistatic measurement via the virtual sensor 6 and the monostatic measurement via the real third radar sensor 3 improves the resolution when acquiring the elevation angle. In the second embodiment example according to FIG. 3, the antenna array 33 of the real third radar sensor 3 and the virtual antenna array 63 of the virtual sensor 6 do not overlap. Thus, the best possible resolution is achieved when acquiring the elevation angle.

In the third embodiment example according to FIG. 4, the antenna array 33 of the real third radar sensor 3 and the virtual antenna array 63 of the virtual sensor 6 overlap 8. In this embodiment example, an additional phase calibration of the third radar sensor 3 and the virtual sensor 6, and thus indirectly also of the two real radar sensors 1, 2, can be carried out. Since the measurements of the overlapping antenna channels, i.e., in this case the lower channel of the antenna array 33 of the third radar sensor 3 and the upper channel of the antenna array 63 of the virtual sensor 6, have to be identical, a correction value of the phase can be determined by comparing the measurements of said overlapping measurement channels. This correction value can also be applied to the non-overlapping antenna channels of the respective sensor 3, 6. Moreover, if the measurements of the overlapping antenna channels are not identical, an error in the assembly or arrangement of the radar sensors 1, 2, 3 can also be ascertained by comparison with a static target.

In the evaluation, the raw data, i.e., for example time signals, spectra, etc., of the third radar sensor 3 and the virtual sensor 6 can be evaluated. Alternatively, preprocessed data are evaluated as shown in FIG. 5. The radar sensors 1, 2, 3 carry out a measurement 100. Each radar sensor 1, 2, 3 records a plurality of detections; for example a distance, a relative speed, an azimuth angle, an area and possibly also an elevation angle of targets. In FIG. 5, the detections of the first radar sensor 1 are labeled 101, the detections of the second radar sensor 2 are labeled 102, and the detections of the third radar sensor 3 are labeled 103. A virtual sensor 6 is created 104 by means of bistatic measurement of the first radar sensor 1 and the second radar sensor 2 using the MIMO method. The detections 101, 102 of the first radar sensor 1 and the second radar sensor 2 linked via the virtual sensor 6 are compared 105 to the detections 103 of the third radar sensor 3. Individual detections can be offset against one another, which reduces the required data rate between the sensors 3, 6. The spatial positions of the detections 101, 102, 103 and the relevant regions of the detections 101, 102, 103 for the sensors 3, 6 are compared with one another. If the detections 101, 102, 103 do not agree, a misalignment is detected and/or corrected 106. If there is sufficient agreement, a joint processing 107 is carried out by offsetting the complex amplitudes of the detections 101, 102, 103 against one another.

1-10. (canceled)

11. A radar system, comprising:
at least three radar sensors which are connected to one another in a phase-coherent manner;
wherein a first radar sensor of the radar sensors and a second radar sensor of the radar sensors are disposed spaced apart from one another, such that a virtual sensor is created using bistatic measurement of at least the first radar sensor and the second radar sensor using a MIMO method, and wherein at least one third radar sensor of the radar sensors is disposed offset to the virtual sensor; and
wherein the radar system is configured to acquire an elevation angle of a target using the virtual sensor and the at least one third radar sensor.

12. A radar system, comprising:
at least three radar sensors which are connected to one another in a phase-coherent manner;
wherein a first radar sensor of the radar sensors and a second radar sensor of the radar sensors are disposed spaced apart from one another, such that a virtual sensor is created using bistatic measurement of at least the first radar sensor and the second radar sensor using the MIMO method, and wherein a third radar sensor of the radar sensors is disposed at a location of the virtual sensor; and
wherein the radar system is configured to calibrate and/or detect a misalignment of the radar sensors using the virtual sensor and the third radar sensor.

13. The radar system according to claim 11, wherein the at least one third radar sensor is disposed such that it is offset in height relative to a plane between the first radar sensor and the second radar sensor.

14. The radar system according to claim 12, wherein the third radar sensor is disposed such that it is offset in height relative to a plane between the first radar sensor and the second radar sensor.

15. The radar system according to claim 11, wherein the at least one third radar sensor is disposed such that it is rotated relative to a plane between the first radar sensor and the second radar sensor.

16. The radar system according to claim 12, wherein the third radar sensor is disposed such that it is rotated relative to a plane between the first radar sensor and the second radar sensor.

17. A method for acquiring an elevation angle using a radar system including at least three radar sensors which are connected to one another in a phase-coherent manner, the method comprising the following steps:
creating a virtual sensor using bistatic measurement of at least the first radar sensor of the radar sensors and a second radar sensor of the radar sensors using a MIMO method; and
evaluating data of the virtual sensor and data of at least one third radar sensor jointly in a phase-coherent manner in order to: (i) acquire an elevation angle of a target, and/or (ii) calibrate and/or detect a misalignment of the radar sensors.

18. The method according to claim 17, wherein raw data from the sensors and/or preprocessed data are used in the joint evaluation.

19. A non-transitory machine-readable storage medium on which is stored a computer program for acquiring an elevation angle using a radar system including at least three radar sensors which are connected to one another in a phase-coherent manner, the computer program, when executed by a computer, causing the computer to perform the following steps:
creating a virtual sensor using bistatic measurement of at least the first radar sensor of the radar sensors and a second radar sensor of the radar sensors using a MIMO method; and
evaluating data of the virtual sensor and data of at least one third radar sensor jointly in a phase-coherent manner in order to: (i) acquire an elevation angle of a target, and/or (ii) calibrate and/or detect a misalignment of the radar sensors.

20. An electronic control unit configured to acquire an elevation angle and/or calibrate and/or detect a misalignment of radar sensors, using a radar system including at least three radar sensors which are connected to one another in a phase-coherent manner, the electronic control unit configured to:
create a virtual sensor using bistatic measurement of at least the first radar sensor of the radar sensors and a second radar sensor of the radar sensors using a MIMO method; and
evaluate data of the virtual sensor and data of at least one third radar sensor jointly in a phase-coherent manner in order to: (i) acquire an elevation angle of a target, and/or (ii) calibrate and/or detect a misalignment of the radar sensors.

21. The radar system according to claim 11, wherein the radar system is situated in a motor vehicle.

22. The radar system according to claim 12, wherein the radar system is situated in a motor vehicle.
